(19) United States
(12) Patent Application Publication
(10) Pub. No.: US 2013/0100541 A1
(43) Pub. Date: Apr. 25, 2013

(54) LENS SYSTEM WITH REDUCED LENGTH AND HIGH RESOLUTION

(71) Applicants: HAI-JO HUANG, Tu-Cheng (TW); AN-TZE LEE, Tu-Cheng (TW); FANG-YING PENG, Tu-Cheng (TW); SHENG-AN WANG, Tu-Cheng (TW); XIAO-NA LIU, Shenzhen (CN)

(72) Inventors: HAI-JO HUANG, Tu-Cheng (TW); AN-TZE LEE, Tu-Cheng (TW); FANG-YING PENG, Tu-Cheng (TW); SHENG-AN WANG, Tu-Cheng (TW); XIAO-NA LIU, Shenzhen (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/494,033

(22) Filed: Jun. 12, 2012

(30) Foreign Application Priority Data
Oct. 25, 2011 (CN) 201110327377.4

(51) Int. Cl. G02B 9/60; G02B 13/18

(52) U.S. Cl. 359/714; 359/770

(57) ABSTRACT

A lens system includes, in this order from the object side to the image side of the lens system, a first lens group and a second lens group. The first lens group includes, in this order from the object side to the image side of the lens system, a first lens of negative refractive power and a second lens of positive refractive power. The second lens group includes, in this order from the object side to the image side of the lens system, a third lens of negative refractive power, a fourth lens positive refractive power, and a fifth lens of negative or positive refractive power. The lens system satisfies the following condition formula: 0.3<fF/fB<1.85, wherein fF, fB are the effective focal lengths of the first and second lens groups, respectively.

### BACKGROUND

1. Technical Field

The present disclosure relates to lenses and, particularly, to a lens system which has a short overall length and a high resolution.

2. Description of Related Art

To efficiently control the aberrations of lens system, additional lenses and/or other optical elements are required, which increases the total length of the lens system.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is a schematic view of a lens system, according to an embodiment.

FIGS. 2-4 are graphs showing the spherical aberration, field curvature, and characteristics curves of the lens system of FIG. 1, respectively, according to a first embodiment.

FIGS. 5-7 are graphs showing the spherical aberration, field curvature, and characteristics curves of the lens system of FIG. 1, respectively, according to a second embodiment.

### DETAILED DESCRIPTION

Embodiments of the present disclosure will be described in detail with reference to the drawings.

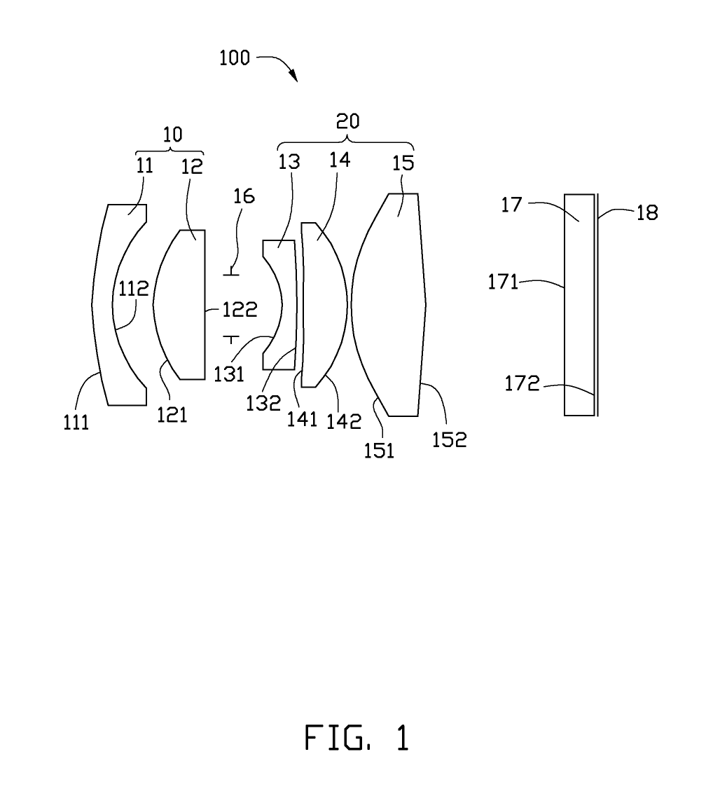

FIG. 1, is a lens system 100, according to an embodiment. The lens system 100 includes, in this order from the object side to the image side of the lens system 100, a first lens group 10, an aperture stop 16, and a second lens group 20.

The first lens group 10 includes, in this order from the object side to the image side of the lens system 100, a first lens 11 of negative refractive power and a second lens 12 of positive refractive power. The second lens group 20 includes, in this order from the object side to the image side of the lens system 100, a third lens 13 of negative refractive power, a fourth lens 14 of positive refractive power, and a fifth lens 15 of negative or positive refractive power.

The first to fifth lenses 11-15 can be made from plastic, polymer, or glass, and, in this embodiment, are made of plastic to reduce cost.

The first, third, fifth lenses 11, 13, 15 are aspheric lenses and each has two aspheric surfaces. The aspherical surface is shaped according to the formula:

$$x = \frac{{ch}^{2}}{1 + \sqrt{1 - ( k + 1 ) {c}^{2} {h}^{2}}} + {\sum }^{ } {Aih}^{i} ,$$

where h is the height from the optical axis of the lens system 100 to a point on the aspherical surface, c is the vertex curvature, k is a conic constant, and Ai is the i-th order correction coefficient of the aspherical surface.

When capturing images, light rays enter the lens system 100, passing through the first to fifth lenses 11-15 in sequence, and then pass through a cover glass 17, and finally form optical images on an image plane 18.

The first lens 11 has an object-side surface 111 (i.e., adjacent to the object side of the lens system 100) and an image-side surface 112 (i.e., adjacent to the image side of the lens system 100). The second lens 12 has an object-side surface 121 and an image-side surface 122. The third lens 13 has an object-side surface 131 and an image-side surface 132. The fourth lens 14 has an object-side surface 141 and an image-side surface 142. The fifth lens 15 has an object-side surface 151 and an image-side surface 152. The cover glass 17 has a surface 171 facing the lens system 100 and a surface 172 facing away from the lens system 100.

The lens system 100 satisfies the following condition formula: 0.3<fF/fB<1.85, wherein fF, fB are the effective focal lengths of the first and second lens groups 10, 20, respectively.

By satisfying the above-mentioned condition formula, a short total overall length and a high resolution can be obtained in the lens system 100. In contrast, if the above-mentioned condition formula is not satisfied, the advantages of the lens system 100 can not be achieved.

To further enhance the resolution of the lens system 100, the lens system 100 further satisfies the following condition formula: 0.48<|f3/f4|<1.42, Wherein f3, f4 are the effective focal lengths of the third and fourth lenses 13, 14.

To efficiently correct lateral aberration occurring in the lens system 100, the lens system 100 further satisfies the condition formulas: 6<V2/V3<2.5 and 1.6<V4/V3<3.6, wherein V2-V4 are the Abbe numbers of light at the wavelength of 587.6 nm (d light) in the second to fourth lenses 12-14, respectively.

The lens system 100 satisfies Tables 1-3 in a first embodiment, where the following symbols are used:
R: the curvature radius of each surface;
D: the distance between each two adjacent surfaces along the optical axis of the lens system 100;
Nd: the refractive index of d light in each lens or the cover glass 17; and
Vd: the Abbe number of d light in each lens or the cover glass 17.

TABLE 1

| Surface | R (mm) | D (mm) | Nd | Vd |
|---|---|---|---|---|
| 111 | 6.651706 | 0.554 | 1.531 | 55.75 |
| 112 | 2.725919 | 1.136 | — | — |
| 121 | 3.187 | 1.417 | 1.596 | 39.22 |
| 122 | −386.787 | 0.728 | — | — |
| 16 | infinity | 1.398 | — | — |
| 131 | −1.700841 | 0.399 | 1.633 | 23.24 |
| 132 | −27.14757 | 0.18 | — | — |
| 141 | −40.641 | 1.213 | 1.596 | 39.22 |
| 142 | −3.253 | 0.099 | — | — |
| 151 | 3.871036 | 2.061 | 1.543 | 56.8 |
| 152 | −9.56112 | 3.93 | — | — |
| 171 | infinity | 0.8 | 1.517 | 64.17 |
| 172 | infinity | 0.1 | — | — |
| 18 | infinity | — | — | — |

TABLE 2

| | Surface | | | | | |
|---|---|---|---|---|---|---|
| | 111 | 112 | 131 | 131 | 151 | 152 |
| K | 0 | 0 | 0 | 0 | 0 | 0 |
| A4 | −0.00087045537 | −0.003541817 | 0.015395688 | −0.0048917803 | −0.0049368649 | 0.0065112019 |
| A6 | −0.00055282669 | −0.0011980595 | 0.0061424656 | 0.0014558243 | 0.00010350228 | −0.0007520526 |
| A8 | 5.9566058 × 10−5 | −7.6390736 × 10−5 | −0.0024374421 | 7.314689 × 10−6 | 2.0066664 × 10−5 | 0.00012344376 |
| A10 | −4.1986206 × 10−6 | 1.5904199 × 10−5 | 0.0021543881 | −1.959752 × 10−5 | −6.8223668 × 10−6 | −1.2918445 × 10−5 |
| A12 | 2.3583807 × 10−7 | −1.8179786 × 10−6 | 0.00021043091 | 9.9686161 × 10−7 | 4.8161694 × 10−7 | −8.475658 × 10−8 |
| A14 | −3.358259 × 10−9 | 2.3295355 × 10−7 | −0.00052830802 | −4.4291647 × 10−7 | −4.9522888 × 10−10 | 1.1230649 × 10−7 |
| A16 | −5.7695815 × 10−11 | −3.7075028 × 10−8 | 0.00017401058 | 1.7441398 × 10−7 | −1.0637237 × 10−9 | −5.7837028 × 10−9 |

TABLE 3

| | |
|---|---|
| fF | 10.324 |
| fB | 5.728 |
| f3 | −2.885 |
| f4 | 5.867 |
| V2 | 39.22 |
| V3 | 23.24 |
| V4 | 39.22 |
| fF/fB | 1.802 |
| \|f3/f4\| | 0.492 |
| V2/V3 | 1.688 |
| V4/V3 | 1.688 |

In this embodiment, the effective focal length of the lens system 100 is about 5.323 mm, the filed of view is about 61 degrees, and the F number is about 2.4.

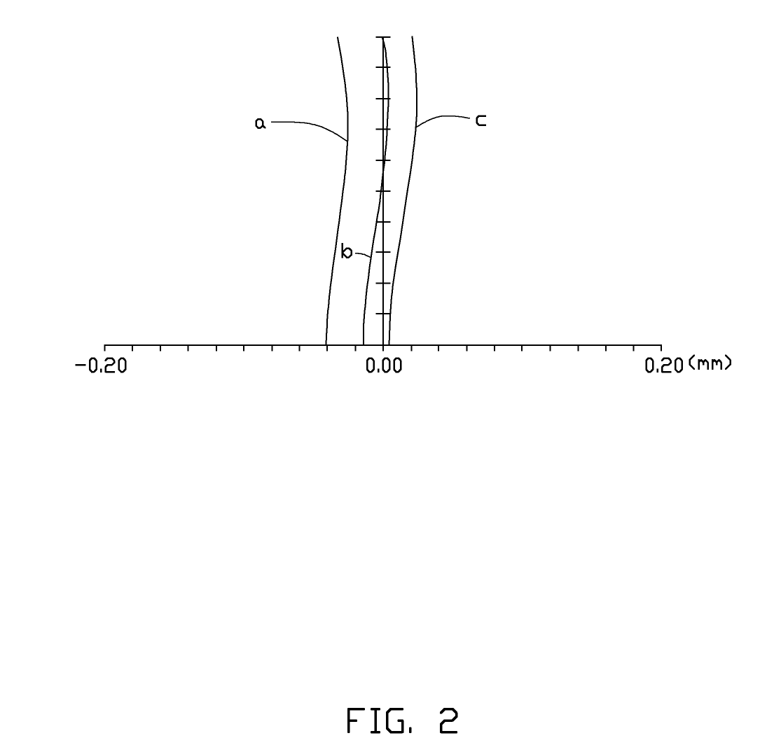

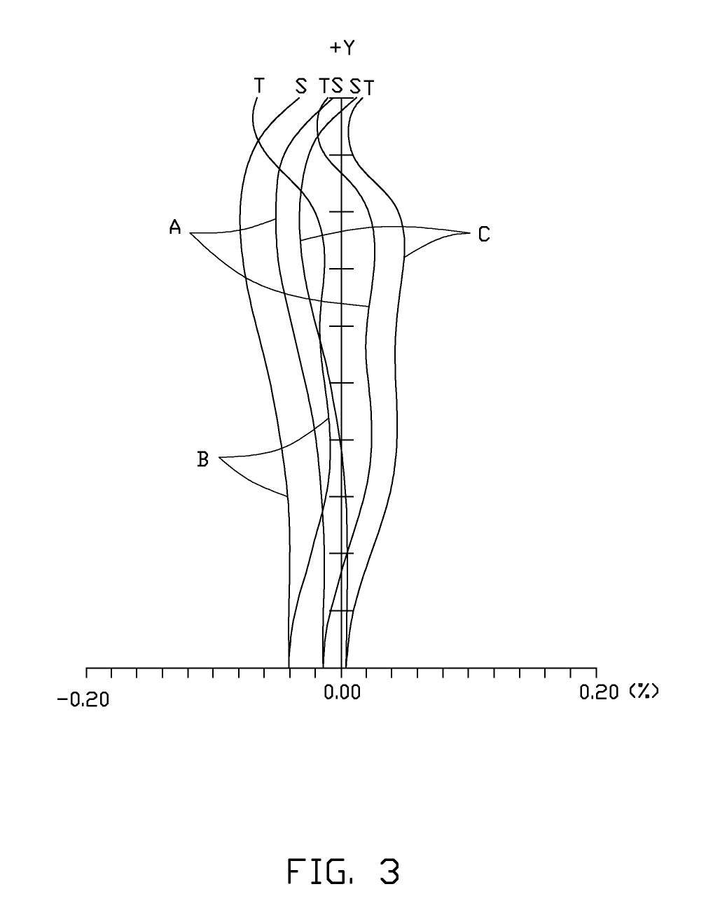

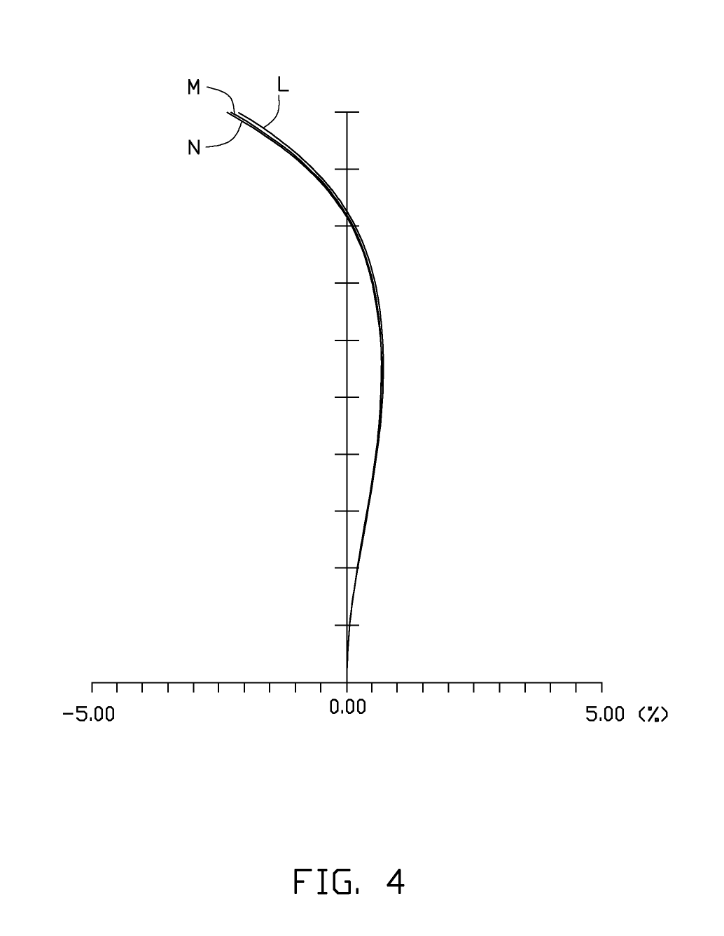

In FIG. 2, the curves a-c show the spherical aberration characteristics of light of the wavelengths 486 nm, 588 nm, 656 nm, respectively, in the lens system 100 of the first embodiment, which are controlled in a range of about −0.2 mm to about 0.2 mm. In FIG. 3, the curves A-C show the meridional (T curves) and sagittal (S curves) field curvatures of light of the wavelength 486 nm, 588 nm, 656 nm, respectively, in the lens system 100 of the first embodiment, which are controlled in a range of about −0.2% to about 0.2%. In FIG. 4, the curves L-N depict the distortion characteristics of light of the wavelengths 486 nm, 588 nm, 656 nm, respectively, in the lens system 100 of the first embodiment, which is controlled in a range of about −5% to about 5%.

The lens system 100 satisfies Tables 4-6 in a second embodiment.

TABLE 4

| Surface | R (mm) | D (mm) | Nd | Vd |
|---|---|---|---|---|
| 111 | 8.423295 | 0.554 | 1.531 | 55.75 |
| 112 | 2.201278 | 2.072 | — | — |
| 121 | 3.901 | 1.246 | 1.697 | 56.42 |
| 122 | −9.944 | 0.099 | — | — |
| 16 | infinity | 1.547 | | — |
| 131 | 7.89663 | 0.4 | 1.633 | 23.24 |
| 132 | 2.649324 | 0.385 | — | — |
| 141 | 6.657 | 2.818 | 1.497 | 81.61 |
| 142 | −3.04 | 1.4 | — | — |
| 151 | −28.94435 | 1.8 | 1.543 | 56.8 |
| 152 | 10.48121 | 0.94 | — | — |
| 171 | infinity | 0.8 | 1.517 | 64.17 |
| 172 | infinity | 0.1 | — | — |
| 18 | infinity | — | — | — |

TABLE 5

| | Surface | | |
|---|---|---|---|
| | 111 | 112 | 131 |
| K | 0 | 0 | 0 |
| A4 | 0.0035852171 | 0.0019255609 | −0.02470804 |
| A6 | −0.0010634939 | −0.0024889945 | 0.0027564826 |
| A8 | 0.00010121061 | 0.00020788899 | −0.002261841 |
| A10 | 2.6358049 × 10−6 | −0.00012220043 | 0.00066508408 |
| A12 | −1.2490536 × 10−6 | 1.9474688 × 10−5 | −6.0769257 × 10−5 |
| A14 | −3.6022421 × 10−8 | −7.5105772 × 10−7 | −4.1177299 × 10−5 |
| A16 | 1.2380055 × 10−8 | −8.4917231 × 10−7 | 8.8464628 × 10−6 |
| | Surface | | |
| | 131 | 151 | 152 |
| K | 0 | 0 | 0 |
| A4 | −0.022246257 | −0.019732317 | −0.020866794 |
| A6 | 0.0020097153 | −0.00019192699 | 1.1238266 × 10−5 |
| A8 | −0.00046837999 | −0.0001503506 | 4.7075407 × 10−5 |
| A10 | −1.0613336 × 10−5 | 0 | 0 |
| A12 | 2.7830166 × 10−5 | 0 | 0 |
| A14 | −7.20013 × 10−6 | −5.4053248 × 10−7 | −4.5456317 × 10−8 |
| A16 | 7.342059 × 10−7 | 4.870945 × 10−8 | 2.5272218 × 10−9 |

TABLE 3

| | |
|---|---|
| fF | 6.418 |
| fB | 19.629 |
| f3 | −6.493 |
| f4 | 4.648 |
| V2 | 56.42 |
| V3 | 23.24 |
| V4 | 81.61 |
| fF/fB | 0.327 |
| \|f3/f4\| | 1.397 |
| V2/V3 | 2.428 |
| V4/V3 | 3.512 |

In this embodiment, the effective focal length of the lens system 100 is about 5.312 mm, the filed of view is about 59 degrees, and the F number is about 2.4.

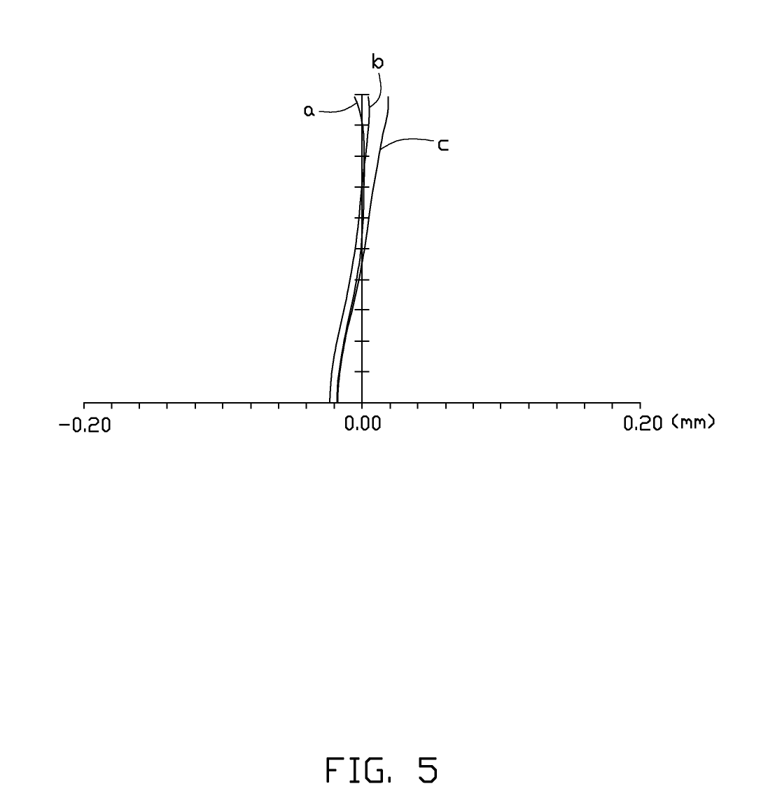

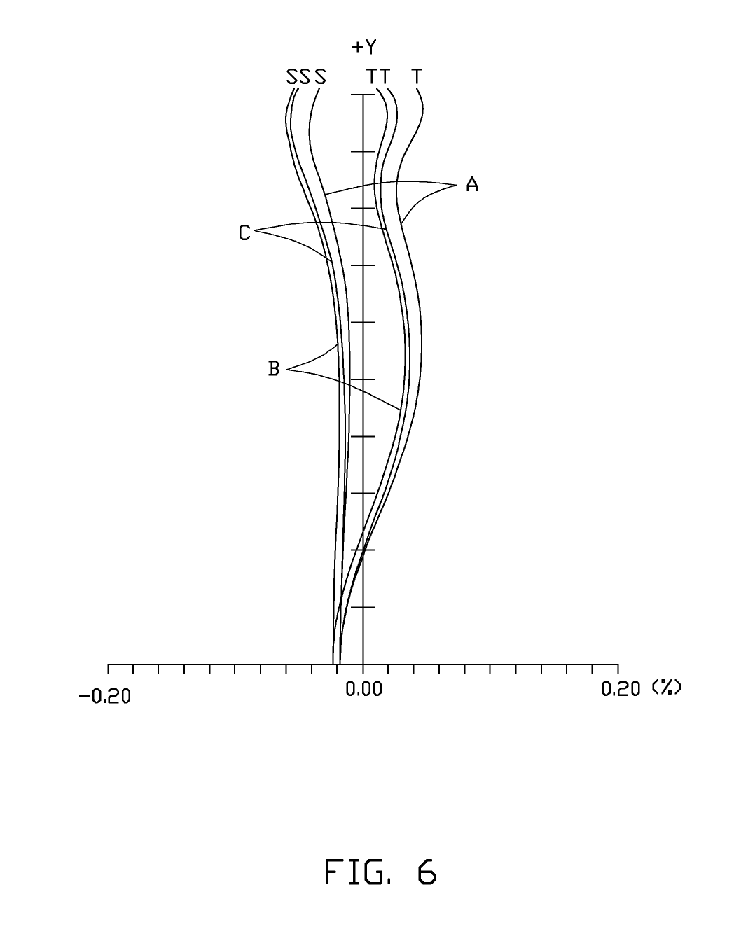

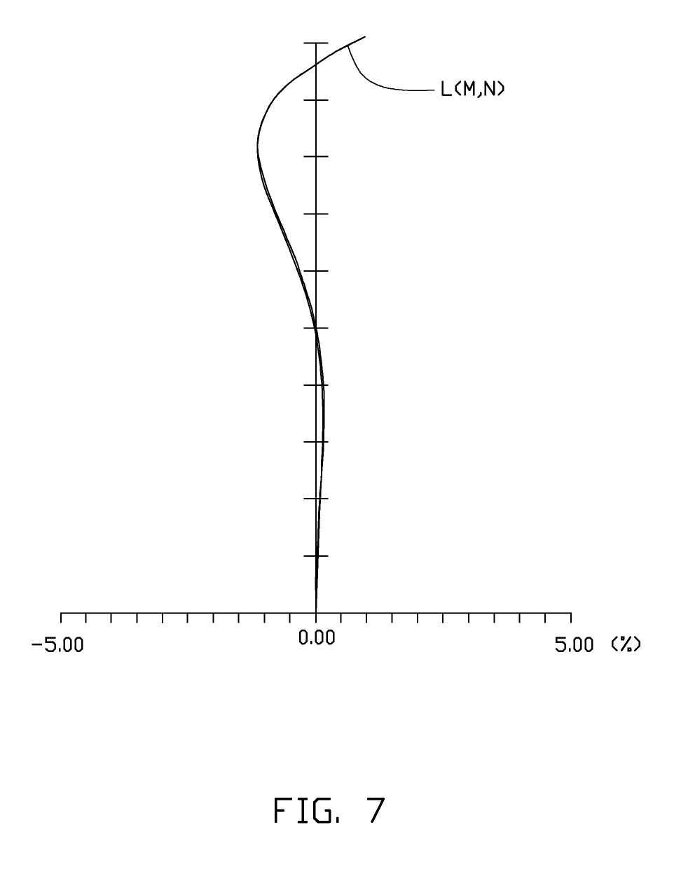

In FIG. 5, the curves a-c show the spherical aberration characteristics of light of the wavelengths 486 nm, 588 nm, 656 nm, respectively, in the lens system 100 of the second embodiment, which are controlled in a range of about −0.2 mm to about 0.2 mm. In FIG. 6, the curves A-C show the meridional (T curves) and sagittal (S curves) field curvatures of light of the wavelength 486 nm, 588 nm, 656 nm, respectively, in the lens system 100 of the second embodiment, controlled in a range of about −0.2% to about 0.2%. In FIG. 7, the curves L-N depict the distortion characteristics of light of the wavelengths 486 nm, 588 nm, 656 nm, respectively, in the lens system 100 of the second embodiment, which is controlled in a range of about −5% to about 5%.

It will be understood that the above particular embodiments are shown and described by way of illustration only. The principles and the features of the present disclosure may be employed in various and numerous embodiment thereof without departing from the scope of the disclosure as claimed. The above-described embodiments illustrate the possible scope of the disclosure but do not restrict the scope of the disclosure.

What is claimed is:

1. A lens system, comprising, in this order from the object side to the image side of the lens system, a first lens group and a second lens group, the first lens group comprising, in this order from the object side to the image side of the lens system, a first lens of negative refractive power and a second lens of positive refractive power; the second lens group comprising, in this order from the object side to the image side of the lens system, a third lens of negative refractive power, a fourth lens positive refractive power, and a fifth lens of negative or positive refractive power, wherein the lens system satisfies the following condition formula: 0.3<fF/fB<1.85, where fF, fB are the effective focal lengths of the first and second lens groups, respectively.

2. The lens system of claim 1, wherein the first to fifth lenses are made from a material selected from the group consisting of plastic, polymer, and glass.

3. The lens system of claim 1, wherein the first, third, fifth lenses are aspheric lenses and each has two aspheric surfaces.

4. Then lens system of claim 1, further comprising an aperture stop interposed between the first and second lens groups.

5. The lens system of claim 1, wherein the lens system further satisfies the following condition formula: 0.48<|f3/f4|<1.42, Wherein f3, f4 are the effective focal lengths of the third and fourth lenses, respectively.

6. The lens system of claim 1, wherein the lens system further satisfies the condition formulas: 6<V2/V3<2.5 and 1.6<V4/V3<3.6, wherein V2-V4 are the Abbe numbers of light at the wavelength of 587.6 nm in the second to fourth lenses, respectively.
